(19) United States
(12) Patent Application Publication
(10) Pub. No.: US 2016/0136608 A1
(43) Pub. Date: May 19, 2016

(54) PLANT AND PROCESS FOR THE EFFICIENT UTILIZATION OF EXCESS ELECTRIC ENERGY

(71) Applicants: Georg MARKOWZ, Alzenau (DE); Florian BÖSS, Hanau (DE); Raoul NEUHAUS, Rodenbach (DE); Swen FRITSCH, Dortmund (DE); EVONIK DEGUSSA GMBH, Essen (DE)

(72) Inventors: Georg Markowz, Alzenau (DE); Florian Böss, Hanau (DE); Raoul Neuhaus, Rodenbach (DE); Swen Fritsch, Dortmund (DE)

(73) Assignee: Evonik Degusssa GmbH, Essen (DE)

(21) Appl. No.: 14/898,998

(22) PCT Filed: May 20, 2014
(86) PCT No.: PCT/EP2014/060310

§ 371 Date: Dec. 16, 2015

(30) Foreign Application Priority Data
Jun. 17, 2013 (DE) 102013010034.8

(51) Int. Cl. B01J 19/00; C01B 3/36; C01B 3/24; C01B 3/34; C25B 1/04; C25B 1/34

(52) U.S. Cl. CPC B01J 19/0033; C25B 1/04; C25B 1/34; C01B 3/24; C01B 3/34; C01B 3/36; B01J 2219/00038; C01B 2203/1647; C01B 2203/1235; C01B 2203/06; C01B 2203/0266; C01B 2203/025; C01B 2203/0205; C01B 2203/1241

(57) ABSTRACT

In a plant comprising a first apparatus for the electrochemical or electrothermal production of hydrogen, which produces a first hydrogen stream; a second apparatus for producing hydrogen from a hydrocarbon by steam reforming, partial oxidation or dehydrogenation, which produces a second hydrogen stream; a hydrogen conduit or a hydrogen consumer to which both the first hydrogen stream and the second hydrogen stream are fed; and a control device which matches the production of hydrogen in the first apparatus and in the second apparatus in such a way that the total amount of first hydrogen stream and second hydrogen stream corresponds to a predetermined value, excess electric energy can be efficiently utilized by operating the apparatus for the electrochemical or electrothermal production of hydrogen with excess electric energy.

The present invention relates to a plant and a process for the efficient utilization of excess electric energy, in which the electric energy is utilized for preparing hydrogen.

The use of renewable energies such as wind energy and solar energy is gaining ever increasing importance for power generation. Electric energy is typically brought to a large number of consumers via long-range, super regional power supply grids coupled over national borders, referred to as power grids for short. Since electric energy cannot be stored to a significant extent in the power grid itself, the electric power fed into the power grid has to be matched to the consumer-side power requirement, known as the load. The load is known to fluctuate in a time-dependent manner, in particular depending on the time of day, day of the week or even time of the year. For a stable and reliable power supply, continuous equality of power generation and power uptake is necessary. Any short-term deviations which occur are equalized by means of positive or negative regulating energy or regulating power. In the case of renewable power generation facilities, there is the difficulty that in the case of particular types, e.g. wind energy and solar energy, energy generation does not occur at every point in time and cannot be controlled in a definite manner but is subject to fluctuations according to the time of day and weather conditions, which fluctuations are foreseeable to only a limited extent and generally do not match the energy demand at the particular time.

The difference between power output from fluctuating renewable energies and the actual consumption is usually provided by other power stations such as gas, coal and nuclear power plants. With increasing expansion of fluctuating renewable energies and the proportion of power supply represented by them, ever larger deviations between their power output and actual consumption have to be equalized. Thus, at the present time gas power plants and increasingly also hard coal power plants are operated at part load or shut down entirely in order to compensate the fluctuations. Since this variable mode of operation of the power plants is associated with considerable additional costs, the development of alternative measures has been examined for some time.

One approach is, in the case of an excess of electric energy, to utilize excess electric energy for preparing hydrogen, for example by electrolytic dissociation of water, as an alternative to or in addition to changing the power output of a power plant. However, when excess electric energy from negative regulating energy is used for hydrogen production, the amount of hydrogen produced likewise fluctuates and generally does not correspond to a demand for hydrogen at a given time. Storage of hydrogen for compensating between the fluctuating production rate and demand is technically complicated and associated with safety risks and storage of hydrogen in liquefied or compressed form is energy-intensive.

As an alternative to storage of hydrogen, reacting the hydrogen with CO₂ or CO to form methanol, methane or higher hydrocarbons and thus convert it into a form which is more easily stored has been proposed. However, this alternative has the disadvantage that additional plants for reacting the hydrogen with CO₂ or CO and the provision of CO₂ or CO are necessary and these reactions additionally consume energy.

Therefore, there is still a need for plants and processes by means of which excess electric energy can be utilized for preparing hydrogen and which do not have the above-described disadvantages of known processes.

The invention provides a plant for the efficient utilization of excess electric energy, which comprises:

a first apparatus for the electrochemical or electrothermal production of hydrogen, which produces a first hydrogen stream;
a second apparatus for producing hydrogen from a hydrocarbon by steam reforming, partial oxidation or dehydrogenation, which produces a second hydrogen stream;
a hydrogen conduit or a hydrogen consumer to which both the first hydrogen stream and the second hydrogen stream are fed; and
a control device which matches the production of hydrogen in the first apparatus and in the second apparatus in such a way that the total amount of first hydrogen stream and second hydrogen stream corresponds to a predetermined value.

The invention also provides a process for the efficient utilization of excess electric energy, in which, in a plant according to the invention, the apparatus for the electrochemical or electrothermal production of hydrogen is operated using excess electric energy.

The plant of the invention comprises a first apparatus for the electrochemical or electrothermal production of hydrogen, which produces a first hydrogen stream. The first apparatus can comprise one or more units in which hydrogen is produced. When the first apparatus comprises a plurality of units for producing hydrogen, these are preferably arranged in parallel and can be operated independently of one another. The use of a plurality of units arranged in parallel allows stepwise alteration of the production of hydrogen while maintaining optimal operating conditions in the individual units by switching on and switching off individual units and avoids efficiency losses due to partial load operation.

In a preferred embodiment, the first apparatus is an apparatus for the electrochemical production of hydrogen by electrolysis of an aqueous solution. Preference is given to using an apparatus for chloralkali electrolysis or for splitting water into hydrogen and oxygen. Particular preference is given to an apparatus for electrolysis of an aqueous solution to form hydrogen and oxygen. The apparatus for the electrochemical production of hydrogen by electrolysis preferably comprises a plurality of electrolysis cells which are arranged in parallel and can be operated independently of one another. Suitable apparatuses for the electrochemical production of hydrogen by electrolysis are known to those skilled in the art from the prior art. The use of an apparatus for the electrolysis of an aqueous solution has the advantage that such apparatuses can be started up and shut down quickly and the output of hydrogen can be changed quickly. In addition, the outlay for keeping such an apparatus ready for quick start-up is lower than in the case of apparatuses for the electrothermal production of hydrogen.

In an alternative preferred embodiment, the first apparatus is an apparatus for the electrothermal preparation of ethyne or hydrogen cyanide in which hydrogen is obtained as coproduct.

In an electrothermal preparation of ethyne, ethyne is prepared in an endothermic reaction from hydrocarbons or carbon and the heat required for carrying out the reaction is generated by electric power. Preference is given to using gaseous or vaporized hydrocarbons, particularly preferably aliphatic hydrocarbons. Methane, ethane, propane and butanes, in particular methane, are particularly suitable. Suitable apparatuses for the electrothermal preparation of ethyne are known from the prior art, for example from Ullmann's Encyclopedia of Industrial Chemistry, Volume 1, 2012 Wiley-VCH Verlag GmbH & Co. KGaA, Weinheim, DOI: 10.1002/14356007.a01_097.pub4, pages 296 to 303, from DE 1 900 644 A1 and from EP 0 133 982 A2.

The apparatus for the electrothermal preparation of ethyne preferably comprises an electric arc reactor. The electrothermal preparation of ethyne can be carried out in a single-stage process in which at least one hydrocarbon is passed through the electric arc with a gas stream. As an alternative, the electrothermal preparation of ethyne can be carried out in a two-stage process in which hydrogen is passed through the electric arc and at least one hydrocarbon is fed downstream of the electric arc into the hydrogen plasma generated in the electric arc. The apparatus for the electrothermal preparation of ethyne preferably comprises a plurality of electric arc reactors which are arranged in parallel and can be operated independently of one another.

In an electrothermal preparation of hydrogen cyanide, hydrogen cyanide is prepared in an endothermic reaction from hydrocarbons or carbon and a nitrogen source and the heat required for carrying out the reaction is generated by electric power. Preference is given to using gaseous or vaporized hydrocarbons, particularly preferably aliphatic hydrocarbons. Methane, ethane, propane and butanes, in particular methane, are particularly suitable. Ammonia is preferably used as nitrogen source.

In a preferred embodiment, the apparatus for the electrothermal preparation of hydrogen cyanide comprises an electric arc reactor in which hydrocarbons are reacted with ammonia or nitrogen. The electrothermal preparation of hydrogen cyanide can be carried out in a single-stage process in which a gas mixture containing ammonia and at least one hydrocarbon is passed through the electric arc. As an alternative, a gas mixture which contains nitrogen and a hydrocarbon and can additionally contain hydrogen is passed through the electric arc. Suitable apparatuses and processes for a single-stage electrothermal preparation of hydrogen cyanide in an electric arc are known from GB 780,080, U.S. Pat. No. 2,899,275 and U.S. Pat. No. 2,997,434. As an alternative, the electrothermal preparation of hydrogen cyanide can be carried out in a two-stage process in which nitrogen is passed through the electric arc and at least one hydrocarbon is fed downstream of the electric arc into the plasma generated in the electric arc. A suitable apparatus and a process for a two-stage electrothermal preparation of hydrogen cyanide is known from U.S. Pat. No. 4,144,444.

Apparatuses for the electrothermal preparation of hydrogen cyanide in an electrically heated fluidized bed of coke according to the Shawinigan process, in which hydrocarbons are reacted with ammonia, as well as apparatuses for the electrothermal preparation of hydrogen cyanide in an electrically heated reactor for the BMA process, in which hydrocarbons are reacted with ammonia in the absence of oxygen and in the presence of a platinum-containing catalyst, are likewise suitable.

In a further preferred embodiment, the first apparatus is an apparatus for the electrothermal splitting of hydrocarbons into carbon and hydrogen. An apparatus for the electrothermal splitting of hydrocarbons in a plasma according to the Kvaerner process is particularly preferred. Suitable apparatuses for such an electrothermal splitting of hydrocarbons are known to those skilled in the art from GB 1 400 266, DD 292 920 and WO 93/20153.

Apart from the first apparatus for the electrochemical or electrothermal production of hydrogen, the plant of the invention further comprises a second apparatus for producing hydrogen from a hydrocarbon by steam reforming, partial oxidation or dehydrogenation, which produces a second hydrogen stream. Suitable apparatuses for producing hydrogen from a hydrocarbon by steam reforming, partial oxidation or dehydrogenation are known to those skilled in the art from the prior art. The second apparatus is preferably an apparatus for the steam reforming of natural gas.

In addition to the first and second apparatus for producing hydrogen, in which a first hydrogen stream and a second hydrogen stream are produced, the plant of the invention also comprises a hydrogen conduit or a hydrogen consumer to which both the first hydrogen stream and the second hydrogen stream are fed. The hydrogen conduit can, for example, be a conduit feeding hydrogen into a pipeline.

The first hydrogen stream and the second hydrogen stream can be fed separately or joined to the hydrogen consumer, with joint feeding being preferred. The hydrogen consumer is preferably a plant in which hydrogen is consumed for one or more chemical reactions, for example for hydrodesulphurization of fuel. The hydrogen consumer preferably comprises a plant for a hydrogenation reaction. The hydrogen consumer is particularly preferably a plant for preparing ammonia from hydrogen and nitrogen, a plant for preparing hydrogen peroxide from hydrogen and oxygen, a plant for hydrogenating an aromatic nitro compound to an aromatic amine, a plant for hydrogenating a nitrile to an amine, a plant for the hardening of an unsaturated fat or oil, a plant for hydrogenating fatty acids to fatty alcohols, a plant for hydrogenating benzene to cyclohexane or a combination of a plurality of these plants.

The plant of the invention further comprises a control device which matches the production of hydrogen in the first apparatus and in the second apparatus in such a way that the total amount of first hydrogen stream and second hydrogen stream corresponds to a predetermined value. The control device can be configured as a discrete control or as a programmed process control system.

The control device preferably comprises additional measurement devices for measuring the mass flow or the volume flow of the first hydrogen stream and the second hydrogen stream. Appropriate measurement devices and control dependent on the measurement result ensure that the total amount of first hydrogen stream and second hydrogen stream corresponds to the predetermined value even when the efficiency of the first or second apparatus for producing hydrogen changes. In addition, it makes it possible to match the production of hydrogen in the first apparatus and in the second apparatus even when an additional hydrogen stream is withdrawn from the first apparatus.

The plant of the invention preferably additionally comprises a buffer reservoir for hydrogen between one of the apparatuses for producing hydrogen and the hydrogen conduit or the hydrogen consumer. The plant can comprise either a single buffer reservoir for hydrogen or a plurality of buffer reservoirs for hydrogen which can be installed downstream of the first apparatus, of the second apparatus or of both apparatuses. The plant particularly preferably has a buffer reservoir for hydrogen between the first apparatus for the electrochemical or electrothermal production of hydrogen and the hydrogen conduit or the hydrogen consumer. In a preferred embodiment, the buffer reservoir or reservoirs is/are connected to the control device and the control device controls the feeding and withdrawal of hydrogen. Suitable buffer reservoirs are, in particular, unpressurized gasometers, pressure vessels, adsorption reservoirs, in which hydrogen is adsorbed on a solid, and chemical reservoirs, in which hydrogen is stored by a reversible chemical reaction. A buffer reservoir allows operation of the plant of the invention in which, in the event of a change in hydrogen production in the first apparatus, the change in hydrogen production in the second apparatus takes place offset in time or at a different speed and a resulting greater or smaller total production of hydrogen is compensated for by feeding hydrogen into the buffer reservoir or withdrawing hydrogen from the buffer reservoir.

In a further preferred embodiment, the plant of the invention additionally comprises an apparatus for purifying hydrogen, preferably an apparatus for removing carbon monoxide and particularly preferably an apparatus for purifying hydrogen by pressure swing adsorption. It is possible to feed the first hydrogen stream, the second hydrogen stream or both hydrogen streams to the apparatus for purifying hydrogen. Suitable apparatuses for purifying hydrogen are known to those skilled in the art from the prior art.

The plant of the invention can also additionally comprise hydrogen compressors by means of which the pressure of the first hydrogen stream and/or of the second hydrogen stream is increased to a value required for the feeding into the hydrogen conduit or to the hydrogen consumer.

The process of the invention for the efficient utilization of excess electric energy is carried out in a plant according to the invention and the apparatus for the electrochemical or electrothermal production of hydrogen is operated using excess electric energy. The excess electric energy can originate from a power generator located adjacent to the plant of the invention, for example a neighbouring power plant, a neighbouring wind generator or a neighbouring photovoltaic plant. The excess electric energy is preferably drawn from a power grid. Particular preference is given to excess electric energy drawn from a power grid as negative regulating energy in order to compensate for an excess of power introduced into the grid compared to the power withdrawn at the given time. For the process of the invention, preference is given to using excess electric energy which is generated from wind energy or solar energy.

In the process of the invention, the first apparatus for the electrochemical or electrothermal production of hydrogen is preferably operated depending on the available supply of excess electric energy. The first apparatus can for this purpose be switched on or off as appropriate, for example depending on the power price on a power exchange at the given time. As an alternative, the first apparatus can also be operated at variable load so that its power consumption corresponds to an excess of electric energy at the given time.

In a preferred embodiment, the process of the invention is carried out in a plant according to the invention which comprises a buffer reservoir for hydrogen and the control device is operated in such a way that in the event of a change in the production of hydrogen in the first apparatus depending on the available supply of excess electric energy, the production of hydrogen in the second apparatus is changed more slowly than the production of hydrogen in the first apparatus and the resulting temporary greater or smaller total production of hydrogen is compensated for by feeding hydrogen into the buffer reservoir or withdrawing hydrogen from the buffer reservoir. The buffer reservoir can be installed either downstream of the first apparatus or downstream of the second apparatus. Likewise, a buffer reservoir can also be installed downstream of both apparatuses. In this embodiment, the production of hydrogen in the first apparatus can be changed more quickly depending on the available supply of excess electric energy and restrictions in respect of the speed of load change in the apparatuses for steam reforming, for partial oxidation or for dehydrogenation of hydrocarbons dictated by the process can be overcome.

In the process of the invention, one or more further hydrogen streams in addition to the first hydrogen stream can be withdrawn from the first apparatus for the electrochemical or electrothermal production of hydrogen and be fed to another apparatus, for example an apparatus for fuelling hydrogen-driven motor vehicles. These additional hydrogen streams do not contribute to the total amount of first hydrogen stream and second hydrogen stream.

In a further preferred embodiment, the process of the invention is carried out in a plant according to the invention in which the second apparatus is an apparatus for the steam reforming of natural gas, which is connected to a natural gas pipeline. An additional apparatus for the steam reforming of natural gas is connected to this natural gas pipeline at a different site. Both apparatuses for steam reforming are controlled by means of a common control device in such a way that when there is a change in the production of hydrogen in the apparatus of the plant according to the invention, the production of hydrogen in the additional apparatus for the steam reforming is changed in the opposite direction. This embodiment enables the total consumption of natural gas to be kept uniform. When the first apparatus of the plant of the invention for the electrochemical or electrothermal production of hydrogen is operated as a function of the excess electric energy available, it is possible, in this embodiment of the process, for the variable production of hydrogen over time, which is dependent on the available excess electric energy, to be carried out at a site different from that at which the electric energy is generated, without a power line being necessary for transmitting electric energy. When the excess electric energy is generated in the vicinity of the plant according to the invention and flow into the natural gas pipeline is effected predominantly from the site of the additional apparatus for the steam reforming of natural gas in the direction of the plant according to the invention, the transmission losses between the site of generation of the excess electric energy and the site of provision of hydrogen as a function of the excess electric energy available are also reduced by this embodiment.

The plant of the invention and the process of the invention allow efficient utilization of excess electric energy in the form of hydrogen, in which, firstly, the amount of excess electric energy can vary quickly and within wide limits and, secondly, the hydrogen can be utilized for applications which have a largely constant hydrogen demand over time, without large storage capacities for hydrogen being necessary for this purpose. The utilization of excess electric energy in the plant of the invention and the process of the invention reduces the need for hydrocarbons for producing hydrogen, with the amount of hydrocarbons saved being significantly greater than the amount of hydrocarbons which could be produced according to the prior art from the hydrogen produced using excess electric energy by reaction with CO₂ or CO to form methane or higher hydrocarbons.

1-14. (canceled)

15. A plant for the efficient utilization of excess electric energy, comprising:
a) a first apparatus for the electrochemical or electrothermal production of hydrogen, which produces a first hydrogen stream;
b) a second apparatus for producing hydrogen from a hydrocarbon by steam reforming, partial oxidation or dehydrogenation, which produces a second hydrogen stream;
c) a hydrogen conduit or a hydrogen consumer to which both the first hydrogen stream and the second hydrogen stream are fed; and
d) a control device matching the production of hydrogen in the first apparatus and in the second apparatus in such a way that the total amount of first hydrogen stream and second hydrogen stream corresponds to a predetermined value.

16. The plant of claim 15, wherein the second apparatus is an apparatus for the steam reforming of natural gas.

17. The plant of claim 15, wherein the first apparatus is an apparatus for the electrolysis of an aqueous solution to form hydrogen and oxygen.

18. The plant of claim 15, wherein the first apparatus is an apparatus for chloralkali electrolysis.

19. The plant of claim 15, wherein the first apparatus is an apparatus for the electrothermal preparation of ethyne or hydrogen cyanide in which hydrogen is obtained as coproduct.

20. The plant of claim 15, wherein the first apparatus is an apparatus for the electrothermal splitting of hydrocarbons into carbon and hydrogen.

21. The plant of claim 15, further comprising a plant for a hydrogenation reaction as hydrogen consumer.

22. The plant of claim 15, further comprising a buffer reservoir for hydrogen between one of the apparatuses for producing hydrogen and the hydrogen conduit or the hydrogen consumer.

23. A process for the efficient utilization of excess electric energy, wherein, in a plant according to claim 15 the apparatus for the electrochemical or electrothermal production of hydrogen is operated using excess electric energy.

24. The process of claim 23, wherein the second apparatus in said plant is an apparatus for the steam reforming of natural gas.

25. The process of claim 23, wherein the first apparatus in said plant is an apparatus for the electrolysis of an aqueous solution to form hydrogen and oxygen.

26. The process of claim 23, wherein the first apparatus in said plant is an apparatus for chloralkali electrolysis.

27. The process of claim 23, wherein the first apparatus in said plant is an apparatus for the electrothermal preparation of ethyne or hydrogen cyanide in which hydrogen is obtained as coproduct.

28. The process of claim 23, wherein the first apparatus in said plant is an apparatus for the electrothermal splitting of hydrocarbons into carbon and hydrogen.

29. The process of claim 23, wherein said plant further comprises a plant for a hydrogenation reaction as hydrogen consumer.

30. The process of claim 23, wherein said plant further comprises a buffer reservoir for hydrogen between one of the apparatuses for producing hydrogen and the hydrogen conduit or the hydrogen consumer.

31. The process of claim 23, wherein the excess electric energy is drawn from a power grid.

32. The process of claim 23, wherein the excess electric energy is generated from wind energy or solar energy.

33. The process of claim 23, wherein the first apparatus for the electrochemical or electrothermal production of hydrogen is operated depending on the available supply of excess electric energy.

34. The process of claim 23, wherein, in said plant according to claim 15, in the event of a change in the production of hydrogen in the first apparatus depending on the available supply of excess electric energy, the production of hydrogen in the second apparatus is changed more slowly than the production of hydrogen in the first apparatus and the resulting temporary greater or smaller total production of hydrogen is compensated for by feeding hydrogen into the buffer reservoir or withdrawing hydrogen from the buffer reservoir.
